(19) United States
(12) Patent Application Publication
(10) Pub. No.: US 2009/0327787 A1
(43) Pub. Date: Dec. 31, 2009

(54) Power monitoring device

(76) Inventors: Yi Gang Yu, Shanghai (CN); Jian Duo Li, Shanghai (CN); Fei Huang Hu, Shanghai (CN); Jian Qiang Wu, Shanghai (CN); Guang Qiang Tang, Shanghai (CN); Ting Xie, Shanghai (CN)

Correspondence Address: HARNESS, DICKEY & PIERCE, P.L.C., P.O.BOX 8910, RESTON, VA, 20195, US

(21) Appl. No.: 12/457,872

(22) Filed: Jun. 24, 2009

(30) Foreign Application Priority Data
Jun. 26, 2008 (CN) 200810130515.8

(51) Int. Cl. G06F 11/30; G06F 17/14

(52) U.S. Cl. 713/340; 708/400; 708/404

(57) ABSTRACT

A power monitoring device is disclosed. In at least one embodiment, the power monitoring device includes a power parameter measurement unit for calculating the measurement results of basic power parameters according to acquired digital signals of a voltage and/or a current; and a power quality analysis unit including a field programmable gate array, for obtaining power quality analysis results by executing a wavelet transform algorithm, a fast Fourier transform algorithm, an artificial neural net algorithm or a fuzzy logic algorithm in a parallel mode according to the acquired digital signals of voltage and/or current to perform analysis of stationary and transient power quality disturbances. Since the power monitoring device of at least one embodiment of the present invention employs a field programmable gate array, it can perform power quality analysis, power parameter measurements and other peripheral functions with relatively good performance.

### PRIORITY STATEMENT

The present application hereby claims priority under 35 U.S.C. §119 on Chinese patent application number CN 200810130515.8 filed Jun. 26, 2008 the entire contents of which are hereby incorporated herein by reference.

### FIELD

At least one embodiment of the present invention generally relates to power monitoring technology and, in particular, to a power monitoring device.

### BACKGROUND ART

Conventional power monitoring devices (abbreviated to PMD) are generally aiming at the measurement of basic power parameters such as current, voltage, power and electric energy values, etc. With the increasingly serious conflicts between the supply and the consumption of energy resources, the demand for monitoring and analyzing power quality is also increasing steadily. In the process of power monitoring, most power quality disturbances are unstable and transient, meaning it is quite difficult to analyze the transient power quality disturbances such as voltage drop, voltage surge, fluctuation, oscillation and temporary interruption, and it is usually necessary to employ complicated algorithms such as wavelet transform, fast Fourier transform (FFT), artificial neural net (ANN) and fuzzy logic (FL) algorithms.

The power monitoring devices that are currently available are generally realized on the basis of a microcontroller unit (MCU) or a digital signal processor (DSP). Since the architecture of a microcontroller unit and a digital signal processor is in series, the power monitoring devices employing such a microcontroller unit and/or a digital signal processor are also of a serial architecture, with their related functions being carried out in succession by a series of instructions. Such serial architectures are usually only suitable for accomplishing jobs of relatively small volumes of calculation and their calculation speeds cannot satisfy the needs of the above-mentioned complicated algorithms like that of wavelet transform, fast Fourier transform (FFT), artificial neural net (ANN) and fuzzy logic (FL). Therefore, the power monitoring devices on the basis of a microcontroller unit or a digital signal processor are only capable of providing basic functions of measuring power parameters and so on, and are difficult in accomplishing the functions of analyzing the power quality.

FIG. 1 shows a currently available power monitoring device realized by combining a microcontroller unit with a digital signal processor. In this case, a current conversion unit converts the input current signals I1, I2, I3 into relatively weak current signals suitable for subsequent processing, and provides them to a sampling and holding unit; a voltage conversion unit converts the input voltage signals U1, U2 and U3 with respect to Un into relatively weak voltage signals suitable for subsequent processing, and provides them to the sampling and holding unit. The sampling and holding unit samples, regulates and filters the voltage coming from the voltage conversion unit, and converts the current from the current conversion unit into a corresponding voltage signal and performs sampling, regulating and filtering, and then provides it to an analog to digital conversion unit to perform analog to digital conversion.

A power parameter measurement unit is realized on the basis of a digital signal processor, and it utilizes the acquired digital signals after the analog to digital conversion to perform the measurement and calculation of the power parameters. A power quality analysis unit is also realized on the basis of a digital signal processor, for performing power quality analysis by virtue of the acquired digital signals after the analog to digital conversion. The measurement results of the power parameters and the analysis results of power quality are provided to a peripheral equipment interface unit realized on the basis of an MCU.

The peripheral equipment interface unit realizes for peripheral equipment the control and interface functions such as memory control, communication control, display control, keyboard control and input/output interface, etc., so as to output the final monitoring and analysis results. Such power monitoring devices can use the digital signal processor therein to realize a small part of the power quality analysis functions, for example, stationary power quality analysis of harmonics, waveforms, event recording, and so on. However, such power monitoring devices are still not capable of performing the analysis of such transient power quality disturbances as voltage drop, voltage surge, oscillation, fluctuation and transient interruption, etc., because those algorithms capable of performing these analyses, such as wavelet transform, artificial neural net (ANN) and fuzzy logic (FL), will bring about very high operation loads, which is very difficult for a power monitoring device with a serial architecture to achieve.

### SUMMARY

In at least one embodiment of the present invention, a power monitoring device is provided to implement power parameter measurement and power quality analysis more comprehensively and with better performance.

The power monitoring device of at least one embodiment of the present invention comprises a power parameter measurement unit, which is used to measure and calculate the measurement results of power parameters according to acquired digital signals of a voltage and/or a current; the power monitoring device further comprises a power quality analysis unit realized by a field programmable gate array, for obtaining the power quality analysis results by way of executing the wavelet transform algorithm, the fast Fourier transform (FFT) algorithm, the artificial neural net (ANN) algorithm or the fuzzy logic (FL) algorithm in a parallel mode according to the acquired digital signals of voltage and/or current, so as to perform analysis of stationary and transient power quality disturbances.

In an example embodiment, the power parameter measurement unit is realized by a field programmable gate array. Preferably, the power monitoring device further comprises a peripheral equipment interface unit for controlling peripheral equipment, so as to provide the power quality analysis results and/or the measurement results of power parameters to the peripheral equipment. Particularly, the peripheral equipment interface unit is realized by a field programmable gate array, a microcontroller unit or a digital signal processor.

In another example embodiment, the power parameter measurement unit is realized by a digital signal processor. Preferably, the power monitoring device further comprises a peripheral equipment interface unit realized by a digital signal processor for controlling the peripheral equipment, so as to provide the peripheral equipment with the power quality analysis results and/or the measurement results of the power parameters.

Furthermore, in at least one embodiment the power monitoring device also comprises: a sampling and holding unit for sampling, regulating and filtering input voltage signals and/or input current signals; and an analog to digital conversion unit for converting the signals coming from the sampling and holding unit into digital signals. Preferably, the power monitoring device further comprises: an analog to digital conversion control unit realized by a field programmable gate array for controlling the analog to digital conversion unit which performs analog to digital conversion in a parallel mode, and for acquiring the digital signals from the analog to digital conversion unit, then providing them to the power quality analysis unit and the power parameter measurement unit.

Particularly, in at least one embodiment the power quality analysis unit comprises: a calculation module for executing in a parallel mode the wavelet transform algorithm, the fast Fourier transform algorithm, the artificial neural net algorithm or the fuzzy logic algorithm according to the acquired digital signals of voltage and/or current; and an analysis module for analyzing the stationary and transient power quality disturbances so as to obtain the analysis results of power quality according to the calculation results of the calculating module.

Since a field programmable gate array is employed, the power monitoring device of the present invention having the above-mentioned configuration is capable of executing algorithms of a large calculation quantity and requiring parallel calculation, such as the wavelet transform, the fast Fourier transform, the artificial neural net and the fuzzy logic with better performance, thereby performing those power quality analysis functions which are difficult for currently available power monitoring devices, and at the same time, it is also capable of performing power parameter measurements and other peripheral functions with good performance.

In an alternative embodiment, it is also possible to employ a digital signal processor or a microcontroller unit to perform the other functions that do not make high demands on computation capability, such as power parameter measurement and other peripheral functions, therefore it can not only perform the power quality analysis to a better standard, but can also reduce the work load of conducting VHDL or Verilog programming to a field programmable gate array, thus shortening the design cycle.

### BRIEF DESCRIPTION OF THE DRAWINGS

FIG. 1 is a schematic diagram of a power monitoring device in the prior art;

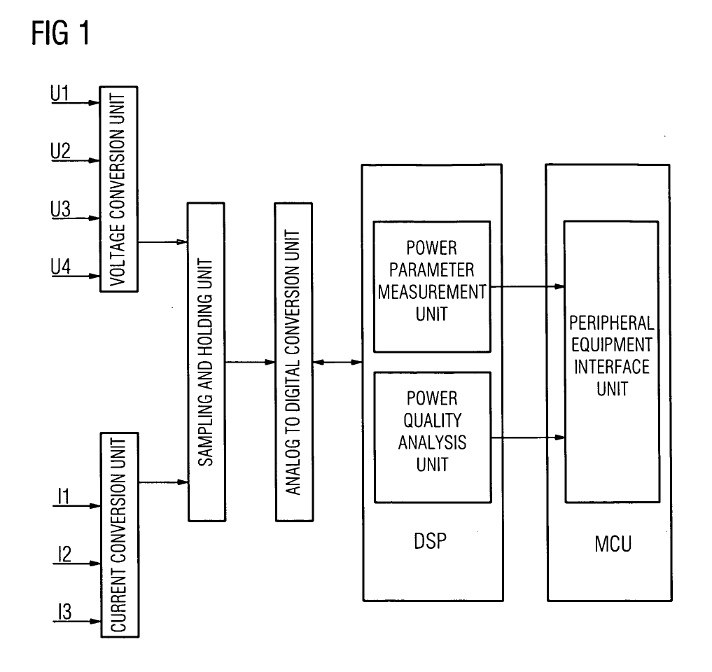

FIG. 2 is a schematic diagram of the construction of the power monitoring device of a first embodiment of the present invention;

FIG. 3 is a schematic diagram of the construction of the power monitoring device of a second embodiment of the present invention;

FIG. 4 is a schematic diagram of the construction of the power monitoring device of a third embodiment of the present invention.

Embodiments of the present invention will be described in detail below with reference to the accompanying drawings.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A field programmable gate array (FPGA) has a parallel architecture, and can provide the calculation and processing performance superior to that of a microcontroller unit or a digital signal processor by way of parallel algorithms. Therefore, an embodiment of the present invention employs a field programmable gate array in a power monitoring device to perform such calculations as wavelet transform, the Fourier transform, artificial neural net and fuzzy logic, thereby performing the power quality analysis function, and enabling the power monitoring device to perform the effective analysis of transient power quality disturbances.

The field programmable gate array can also be used to realize other functions in a power monitoring device, such as the function of measuring and calculating basic power parameters, the function of controlling analog to digital conversion, the function of interfacing with peripheral equipment, etc., and since the field programmable gate array is capable of processing in parallel, it can also enable the power monitoring device to achieve better performance, in addition to realizing these other functions.

In addition, in consideration of reducing the programming of the field programmable gate array and of shortening the design cycle, an embodiment of the present invention further provides the architecture for a power monitoring device in which the field programmable gate array is combined with a microcontroller unit or a digital signal processor.

The power monitoring device of embodiments of the present invention will be described in detail below by way of particular embodiments.

### Embodiment One

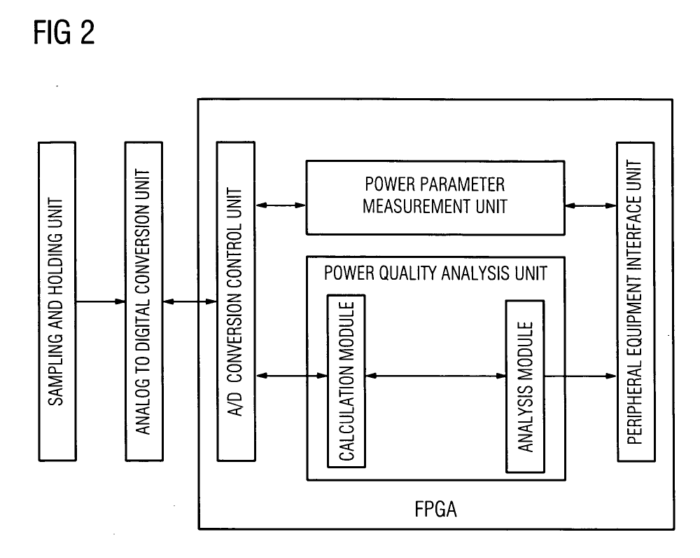

FIG. 2 is a schematic diagram of the construction of the power monitoring device of the first embodiment of the present invention. The first embodiment employs a field programmable gate array to replace the microcontroller unit and/or the digital signal processor in those power monitoring devices that are currently available, thus allowing the power monitoring device of the first embodiment to be capable of performing the function of full power quality analysis, and at the same time, it can also perform such functions as power parameter measurement, analog to digital conversion control and interfacing with peripheral equipment.

The power monitoring device of the first embodiment comprises: a sampling and holding unit, an analog to digital conversion unit, an analog to digital conversion control unit, a power quality analysis unit, a power parameter measurement unit and a peripheral equipment interface unit.

In this case, the sampling and holding unit and the analog to digital conversion unit are realized in the same manner as the sampling and holding unit and the analog to digital conversion unit in a currently available power monitoring device. The sampling and holding unit is used to sample, regulate and filter the input voltage signals, and to convert the input current signals to corresponding voltage signals and perform sampling, regulating and filtering. The analog to digital conversion unit is used to convert the signals coming from the sampling and holding unit into digital signals.

In order to make the system operate with a higher efficiency, the power monitoring device further comprises an analog to digital conversion control unit, which is realized by a field programmable gate array, for controlling the analog to digital conversion unit which executes the analog to digital conversion and for acquiring converted digital signals from the analog to digital conversion unit, for example, providing the analog to digital conversion unit with a trigger signal for starting the conversion, reading the converted digital signals from the analog to digital conversion unit when receiving an interruption indication for the termination of the conversion of the analog to digital conversion unit, and then providing the power quality analysis unit and the power parameter measurement unit with the acquired digital signals of voltage and/or current. Since the field programmable gate array is capable of processing in parallel, the analog to digital conversion control unit can perform interaction with the analog to digital conversion unit in a parallel mode, which can also improve the performance of the power monitoring device. The analog to digital conversion control unit can also store the read digital signals first, and then provide them at an appropriate time to the power quality analysis unit and the power parameter measurement unit.

The core functions of the power monitoring device are mainly accomplished by the power quality analysis unit and the power parameter measurement unit.

The power quality analysis unit is realized by a field programmable gate array (FPGA) for executing in a parallel mode, according to acquired digital signals of a voltage and/or a current, the calculation of the wavelet transform algorithm, the fast Fourier transform algorithm, the artificial neural net algorithm or the fuzzy logic algorithm, and for carrying out analysis of stationary and transient power quality disturbances to obtain the analysis results of power quality. The power quality analysis unit can further store the calculation results by executing the above-mentioned algorithms and the power quality analysis results obtained through analysis for subsequent steps. The transient power quality disturbances can be voltage drop, voltage surge, oscillation, fluctuation or temporary interruption. Specific methods for analyzing these stationary and transient power qualities by employing the wavelet transform algorithm, the fast Fourier transform algorithm and so on can refer to the prior art.

Particularly, the power quality analysis unit can comprise: a calculation module and an analysis module. The calculation module is used to execute in a parallel mode, according to the acquired digital signals of voltage and/or current, the computation of the wavelet transform algorithm, the fast Fourier transform algorithm, the artificial neural net algorithm or the fuzzy logic algorithm. The calculation module can also be used to store the calculation results of the above algorithms. The analysis module is used to carry out the detection, classification and analysis of the stationary and transient power quality disturbances according to the calculated results of the calculation module, thereby obtaining the analysis results of the power quality. The analysis module can also be used to store the results of the power quality analysis.

The power parameter measurement unit is used to carry out measurement and calculation according to the digital signals from the analog to digital conversion unit to obtain the measurement results of the power parameters. The power parameter measurement unit can furthermore be used to store the above measurement results for use in subsequent steps. The above power parameters can be certain basic power parameters, such as voltage, current, frequency, power or electric energy values, etc., of which the measurement results can be obtained by employing the currently available measurement and calculation methods. In the first embodiment, the power parameter measurement unit is realized by a field programmable gate array.

The above measurement results and analysis results of the power monitoring device generally need to be outputted to users via the peripheral equipment, and the peripheral equipment can be communication devices, display devices, keyboards, memories and I/O interfaces, etc. For this reason, the power monitoring device can further comprise a peripheral equipment interface unit, which is used to perform the functions of controlling and interfacing with peripheral equipment, so as to output the analysis results of the power quality and/or the measurement results of the power parameters through the peripheral equipment. In the first embodiment, the peripheral equipment interface unit is realized by a field programmable gate array.

### Embodiment Two

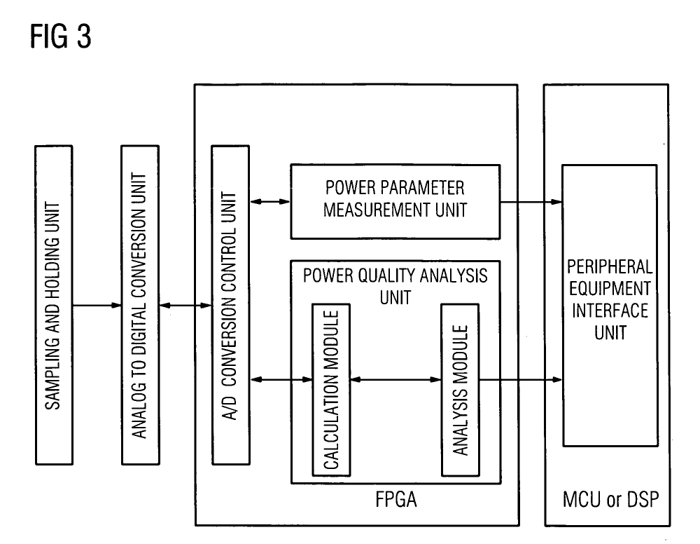

FIG. 3 is a schematic diagram of the construction of the power monitoring device of the second embodiment of the present invention. The difference between the second embodiment and the first embodiment lies in that, in the power monitoring device of the second embodiment, the peripheral equipment interface unit is realized by a microcontroller unit or a digital signal processor.

The advantage of employing such an architecture to implement the power monitoring device lies in that the field programmable gate array is mainly used to perform the core functions of large calculation volumes, such as the power quality analysis and power parameter measurement, while peripheral functions, etc., are performed by the microcontroller unit or digital signal processor, thereby achieving better performance of power quality analysis and power parameter monitoring. In addition, by way of performing a part of the functions by employing a microcontroller unit or a digital signal processor, the work load of performing, for example VHDL or Verilog, programming to the field programmable gate array can also be reduced, so that the design cycle is shortened.

### Embodiment Three

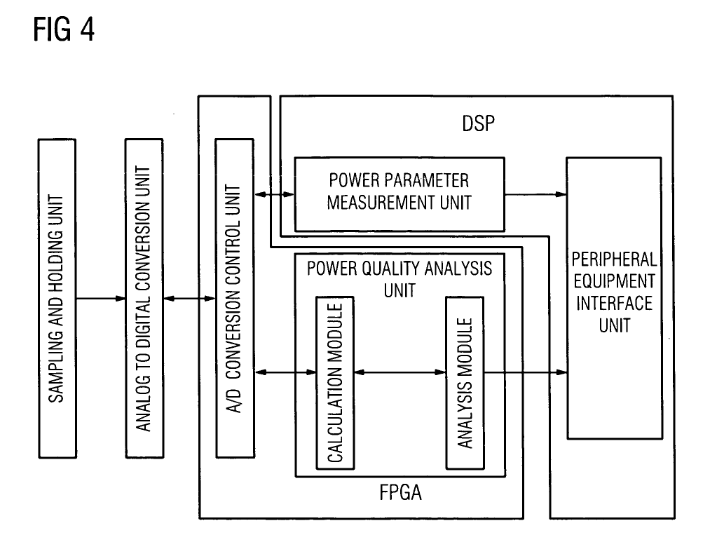

FIG. 4 is a schematic diagram of the construction of the power monitoring device of the third embodiment of the present invention. The difference between the third embodiment and the first embodiment lie in that, in the power monitoring device of the third embodiment, the power parameter measurement unit and the peripheral equipment interface unit are realized by a digital signal processor.

The advantage of employing such an architecture to implement the power monitoring device lies in that the field programmable gate array is dedicated to performing such functions as those with large computation volume and of requiring parallel calculation, like the power quality analysis, while the power parameter measurement and other peripheral functions are performed by the digital signal processor, thereby achieving better performance of the power quality analysis and power parameter monitoring, and at the same time, by means of performing some of the functions by employing a digital signal processor, the work load in performing, for example VHDL or Verilog programming to the field programmable gate array, can also be reduced, so that the design cycle is shortened.

It is understandable to those skilled in the art that other combined architecture of the field programmable gate array with the digital signal processor and the microcontroller unit can also be employed to perform the functions of power monitoring devices. For example, a field programmable gate array performs the function of power quality analysis, a digital signal processor performs the function of power parameter measurement, and a microcontroller unit performs the function of interfacing with peripheral equipment. Therefore, the above embodiments are merely preferred embodiments of the present invention, and are not intended to limit the protective scope of the present invention. Any modification, equivalent substitution and improvement within the spirit and principle of the present invention are to be covered within the protective scope of the present invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power monitoring device, comprising:
a power parameter measurement unit to measure and to calculate measured results of the power parameters obtained according to acquired digital signals of at least one of a voltage and a current; and
a power quality analysis unit to analyze results of power quality obtained according to the acquired digital signals of at least one of the voltage and the current,
the power quality analysis unit including a field programmable gate array to execute, in a parallel mode, a calculation of a wavelet transform algorithm, a fast Fourier transform algorithm, an artificial neural net algorithm or a fuzzy logic algorithm, so as to analyze stationary and transient power quality disturbances and to obtain analysis results of power quality.

2. The power monitoring device as claimed in claim 1, wherein said power parameter measurement unit includes a field programmable gate array.

3. The power monitoring device as claimed in claim 1, further comprising:
a peripheral equipment interface unit to control peripheral equipment so as to provide the peripheral equipment with at least one of the analysis results of the power quality and the measurement results of the power parameters.

4. The power monitoring device as claimed in claim 3, wherein said peripheral equipment interface unit includes a field programmable gate array, a microcontroller unit or a digital signal processor.

5. The power monitoring device as claimed in claim 1, wherein said power parameter measurement unit includes a digital signal processor.

6. The power monitoring device as claimed in claim 5, further comprising:
a peripheral equipment interface unit, including a digital signal processor, to control peripheral equipment, so as to provide the peripheral equipment with the analysis results of at least one of the power quality and the measurement results of the power parameters.

7. The power monitoring device as claimed in claim 1, further comprising:
a sampling and holding unit to sample, regulate and filter at least one of input voltage signals and input current signals; and
an analog to digital conversion unit, to convert the signals from said sampling and holding unit into digital signals.

8. The power monitoring device as claimed in claim 7, further comprising:
an analog to digital conversion control unit, including a field programmable gate array, to control, in a parallel mode, the analog to digital conversion unit which performs the analog to digital conversion, and to acquire said digital signals from said analog to digital conversion unit, and then provide the acquired said digital signals to said power quality analysis unit and said power parameter measurement unit.

9. The power monitoring device as claimed in claim 1, wherein said power quality analysis unit comprises:
a calculation module to execute, in a parallel mode, the calculation of the wavelet transform algorithm, the fast Fourier transform algorithm, the artificial neural net algorithm or the fuzzy logic algorithm according to the acquired at least one of digital signals of the voltage and the current; and
an analysis module to analyze the stationary and transient power quality disturbances according to the calculated results of said calculation module, so as to obtain the analysis results of the power quality.

10. A power monitoring device, comprising:
power parameter measurement means for measuring and for calculating measured results of power parameters obtained according to acquired digital signals of at least one of a voltage and a current; and
power quality analysis means for analyzing results of power quality obtained according to the calculated measured digital signals of at least one of the voltage and the current,
the power quality analysis means including,
field programmable gate array means for executing, in a parallel mode, a calculation of a wavelet transform algorithm, a fast Fourier transform algorithm, an artificial neural net algorithm or a fuzzy logic algorithm, so as to analyze stationary and transient power quality disturbances and to obtain analysis results of power quality.

11. A power monitoring method, comprising:
measuring and calculating measured results of power parameters obtained according to acquired digital signals of at least one of a voltage and a current; and
analyzing results of power quality obtained according to the calculated measured digital signals of at least one of the voltage and the current,
the analyzing including,
executing, in a parallel mode, a calculation of a wavelet transform algorithm, a fast Fourier transform algorithm, an artificial neural net algorithm or a fuzzy logic algorithm, so as to analyze stationary and transient power quality disturbances and to obtain analysis results of power quality.

12. A computer readable medium including program segments for, when executed on a computer device, causing the computer device to implement the method of claim 11.

13. The power monitoring device as claimed in claim 2, further comprising:
a peripheral equipment interface unit to control peripheral equipment so as to provide the peripheral equipment with at least one of the analysis results of the power quality and the measurement results of the power parameters.

14. The power monitoring device as claimed in claim 13, wherein said peripheral equipment interface unit includes a field programmable gate array, a microcontroller unit or a digital signal processor.
